(19) United States
(12) Patent Application Publication
(10) Pub. No.: US 2012/0285478 A1
(43) Pub. Date: Nov. 15, 2012

(54) Disposable Flosser

(75) Inventors: Bradley Page Griffin, Greenville, NC (US); Paul Durant Gallup, Greenville, NC (US)

(73) Assignee: PRACTICON, INC., Greenville, NC (US)

(21) Appl. No.: 13/468,579

(22) Filed: May 10, 2012

Related U.S. Application Data
(60) Provisional application No. 61/484,741, filed on May 11, 2011.

(51) Int. Cl. A61C 15/04

(52) U.S. Cl. 132/200; 132/323

(57) ABSTRACT

The flossing of teeth for users wearing braces is facilitated by a device having a handle attached to side supporting elements and a central tip element where a piece of dental floss is attached to the side supporting elements. The side supporting elements and a central tip element are attached to the handle with a strand of dental floss rigidly connected to the side supporting elements and passing through the central tip element. The central tip element is thin enough to enter the space between the tooth and the brace wire. The user may position the central tip element into the space between a tooth and the brace wire such that one of the side supporting elements is positioned in the mouth and the user may then move the handle in an up and down motion in order to floss between the teeth.

### RELATED APPLICATION

This patent application is related to and claims priority to U.S. Provisional Patent Application No. 61/484,741, filed on May 11, 2011, entitled “Disposable Flosser,” the entire disclosure of which is incorporated herein by reference.

### FIELD OF THE INVENTION

The present invention generally relates to a dental device. In particular, the present invention is directed to a disposable flossing tool that can be used when teeth are affixed with braces.

### BACKGROUND OF THE INVENTION

Persons wearing braces have a difficult time flossing their teeth because the wire situated on their teeth obstructs the floss from moving up and down. Although regular flossing techniques can be used to clean between the teeth from the bottom of the teeth to the wire, it is difficult to insert the floss between the teeth in the area from the wire to the gums.

Flossing tools intended for teeth with and without braces have been proposed in the past. For example, U.S. Pat. No. 6,089,241 provides a dental flosser comprised of a casing having a housing at one end for holding a supply of floss and a bent floss outlet section at the other end of the housing forming an arc. However, this flosser is merely designed to provide adjustable tension on the floss and is not used for flossing teeth with braces, particularly with the large center flexible rod support of the flosser.

U.S. Patent Publication 2008/0223398 is directed to a flossing tool comprising two support elements wherein one of the support elements is thin enough to fit between the teeth and the wire of the braces. However, the thin support element is not sturdy enough to hold the floss rigidly in place during use and leads to breakage of the floss strand away from the flosser and subsequent loss of functionality of the device.

### BRIEF DESCRIPTION OF THE INVENTION

The present invention is directed to a dental flosser that can be easily used to floss teeth affixed with braces and that provides two usable segments of floss in one handle. The flossing device may be composed of a handle attached to side supporting elements where the handle and side supporting elements are composed in a vertical attachment. The side supporting elements are attached to the handle and descend below the handle. A central tip element attached to the handle is disposed at a point equidistant between the side supporting elements and where the central tip element is of sufficient width and thickness to enter the space between the tooth and the brace wire. A strand of dental floss may be rigidly connected to the distal end of the side supporting elements and passing through the distal end of the central tip element.

In another embodiment, a method for flossing teeth using a dental flosser is provided. The method comprises positioning the central tip element of the above dental flosser into the space between a tooth and the brace wire such that one of the side supporting elements is positioned in the mouth and the user may then move the handle in an up and down motion in order to floss between the teeth. As the floss becomes less effective in the removal of debris from between the teeth, the user may rotate the flossing device such that the second of the side supporting elements is positioned in the user's mouth to continue flossing as necessary.

### BRIEF DESCRIPTION OF THE DRAWINGS

FIG. 1A illustrates an angled view of the dental flosser consistent with certain embodiments of the invention;

FIG. 1B illustrates a cross-sectional view of the dental flosser and shows a dimensional view of a central tip element of the dental flosser consistent with certain embodiments of the invention;

FIG. 1C illustrates a front view of the dental flosser consistent with certain embodiments of the invention;

FIG. 1D illustrates a view of a side support element of the dental flosser consistent with certain embodiments of the invention; and

FIG. 2 illustrates a view of a certain embodiment of the invention in use.

### DETAILED DESCRIPTION OF THE INVENTION

The present invention relates to a flossing tool that can be used to floss teeth affixed with braces, as well as to floss teeth without braces. Specifically, the present invention discloses a double dental flosser including outside support posts and a central tip element that allows a user to easily floss between teeth with braces.

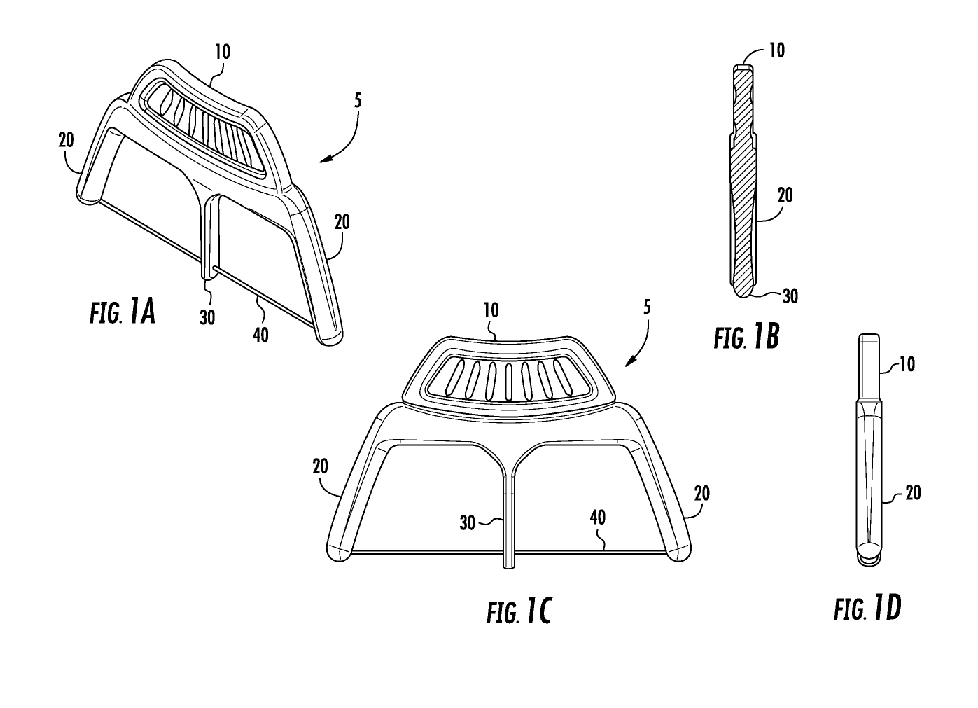

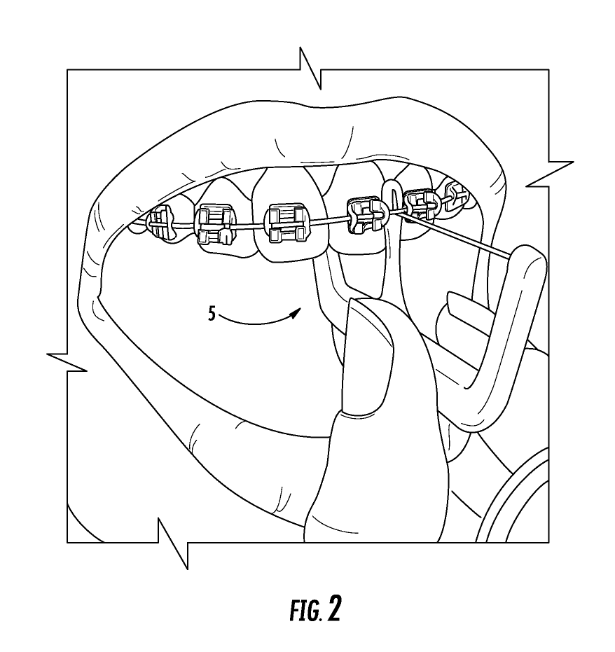

FIG. 1A presents an exemplary angled view of a dental flosser 5. The dental flosser 5 is comprised of a handle 10, two side support elements 20, a central tip element 30, and a strand of dental floss 40. The handle 10 is affixed into the two side support elements 20 at either end of the handle 10 such that each side support element 20 descends from the handle 10 and the handle 10 and side support elements 20 are aligned in the same horizontal orientation. Additionally, the handle design presented in FIG. 1A is one exemplary representation for the handle 10 design. The handle 10 may be designed to present a smooth surface, or may be designed with ridges, indentations, voids, or any other design feature to allow the user to firmly grip the handle 10 during use of the dental flosser 5 without departing from the scope of the present invention. The handle 10 may have a flat grip portion adapted to be grasped between a thumb and a finger of the user, such that the grip portion defines a grip plane. The handle 10 material may have spring characteristics and include non-slip material. The central tip element 30 descends from a point in the handle 10 that is equidistant from the two side support elements 20 and is also aligned in the same horizontal orientation as the handle 10 and the two side support elements 20. The distal portion of the central tip element 30 may be configured to be wider, and thinner, than the proximal portion such that the central tip element 30 may be spatula shaped or rounded paddle shape. The spatula or rounded paddle shape helps guide the central tip element 30 into the space between the tooth and the brace wire. The two side support elements 20 are attached at the proximal end to the handle 10 and provide a rigid support structure for a strand of dental floss 40 at the distal end of the support elements 20. The two side supporting elements 20 may be of a thicker dimension than the central tip element 30. The distal ends of the side supporting elements 20 may be rounded for user comfort. The floss strand 40 is rigidly seated in each side support element 20. The strand of dental floss 40 is attached at the first of the side support elements 20, passes through the central tip element 30 and is attached at the second of the side support elements 20 in such a manner as to hold the dental floss 40 rigidly in place between the two side support elements 20. The central tip element 30 holds the dental floss 40 in a vertical direction, but the dental floss 40 is not rigidly attached to the central tip element 30. The dental floss 40 preferably slides through the central tip element 30 to allow for the uninvolved segment of dental floss 40 to bend under a brace wire during use, as shown, for example, in FIG. 2. The central tip element 30 thus serves as a guide for the dental floss 40 in the vertical direction and does not allow the dental floss 40 to move out of the horizontal direction and remain in alignment with the two side support elements 20.

FIG. 1B presents an exemplary cross-sectional view of dental flosser 5, showing a side view of the central tip element 30. In an exemplary embodiment, the dental flosser 5 may be constructed of plastic, where the handle 10, side support elements 20, and central tip element 30 are constructed as a single injection molded plastic part. In an alternative embodiment the dental flosser 5 may be made from high strength plastic, rubber, or any other material suitable for a dental appliance. Additionally, in an exemplary embodiment, constructing the dental flosser 5 of higher strength materials may allow the handle 10 and the central tip element 30 to be reduced in dimension to provide for a patient with smaller teeth and correspondingly smaller distances between the wires of a brace and the teeth to which the braces are affixed.

FIG. 1C presents an exemplary front view of the dental flosser 5. In one exemplary embodiment the dental flosser 5 may be in the range of about 1.0 to about 1.1 inches in vertical dimension from the top edge of the handle 10 to the bottom edge of the side support elements 20. In alternative embodiments, slightly smaller and larger vertical dimensions from the top edge of the handle 10 to the bottom edge of the side support elements 20 are contemplated without departing from the scope of the present invention. The central tip element 30 is configured such that it descends below the handle 10 and positioned equidistant from each of the two side support elements 20. In one exemplary embodiment the central tip element 30 may be approximately 0.05 inches in thickness. In this exemplary embodiment, the dental flosser 5 may be held at the handle 10 in a vertical orientation with the dental flosser 5 perpendicular to the surface of the tooth. The floss 40 is rigidly attached to the side support elements 20 and passes through the central tip element 30 and is held in a vertical orientation by the central tip element 30. The central tip element 30 may then be inserted between the wire of an orthodontic brace wire and the surface of a tooth, the floss 40 is inserted between the teeth, and the dental flosser 5 is moved up and down to clean between the teeth. In alternative embodiments the central tip element 30 may be slightly wider or narrower in width and/or slightly thinner or thicker in thickness to accommodate differing materials used for construction of the dental flosser 5 or different expected gaps between an orthodontic brace wire and the surface of a tooth into which the central tip element 30 may be inserted without departing from the scope of the present invention. The dental flosser 5 is a device that may be discarded after use to facilitate proper hygiene.

FIG. 1D presents an exemplary side view of the side support elements 20. The side support elements 20 descend from the handle 10 and are formed as a continuous construction from the handle 10, where the handle 10 may be in the range of about 0.09 to about 0.10 inches in width and the side support elements 20 may be in the range of about 0.12 to about 0.13 inches in width. In alternative embodiments the side support elements 20 and the handle 10 may be slightly wider or narrower to accommodate the strength of the material of which the dental flosser 5 is composed. The side support elements 20 are formed of sturdy construction sufficient to hold the floss 40 in place and keep the floss 40 from detaching from the side support elements 20 during the insertion of floss 40 between the teeth during the use of the dental flosser 5.

The dental flosser 5 may be used for flossing spaces between the teeth of a user having braces, the braces including a brace wire spaced apart from the teeth. The dental flosser 5 may be composed of a handle 10 attached to side supporting elements where the handle 10 and side supporting elements 20 are composed in a vertical attachment. The side supporting elements 20 are attached to the handle 10 at the proximal ends and descend below the handle 10. A central tip element 30 attached at the proximal end to the handle 10 is disposed at a point equidistant between the side supporting elements 20 and where the central tip element 30 is of sufficient width and thickness to enter the space between the tooth and the brace wire. A strand of dental floss 40 may be rigidly connected to the distal end of the side supporting elements 20 and passing through the distal end of the central tip element 30. The user may position the central tip element 30 into the space between a tooth and the brace wire such that one of the side supporting elements 20 is positioned in the mouth and the user may then move the handle 10 in an up and down motion in order to floss between the teeth. As the floss 40 becomes less effective in the removal of debris from between the teeth, the user may rotate the dental flosser 5 such that the second of the side supporting elements 20 is positioned in the user's mouth to continue flossing as necessary.

The present invention allows a user, to quickly and easily floss behind a brace wire. With other orthodontic flossers, the floss can easily break or come loose from the thinner side support extensions. The present invention features secure end points formed of sturdy construction to solve this problem. Additionally, the present invention's double-ended design provides two flossers in one handle. The present invention may be used for both orthodontic and non-orthodontic users.

### Concluding Remarks

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

We claim:

1. A dental flossing device comprising:
a handle attached to side supporting elements where the handle and side supporting elements are composed in a vertical attachment, the side supporting elements attached to the handle at the proximal ends and descending below the handle;
a central tip element attached at the proximal end to the handle and disposed at a point equidistant between the side supporting elements;
a floss strand rigidly connected to the distal end of the side supporting elements and passing through the distal end of the central tip element.

2. The dental flossing device of claim 1 where the central tip element with width and thickness dimensions sufficient to permit the central tip element to pass between a tooth and an orthodontic brace wire spaced apart from the tooth.

3. The dental flossing device of claim 1 where the device is disposable.

4. The dental flossing device of claim 1 where the distal end of the central tip element is of a wider dimension than the proximal end.

5. The dental flossing device of claim 1 where the handle, the side supporting elements, and the central tip element are composed of plastic.

6. The dental flossing device of claim 5 where the handle, the side supporting elements, and the central tip element comprise a single injection molded plastic construction.

7. The dental flossing device of claim 1 where the central tip element provides an aperture through which dental floss is held in vertical alignment with the side supporting elements.

8. The dental flossing device of claim 1 where the side supporting elements are of a thicker width dimension than the central tip element.

9. The dental flossing device of claim 1 where the handle comprises a flat grip portion adapted to be grasped between the thumb and a finger of a user, such that the grip portion defines a grip plane.

10. The dental flossing device of claim 9 where the handle is sculpted in patterns using voids and ridges and other features to facilitate the grip of a user on the handle during use.

11. The dental flossing device of claim 1 where the distal end of the central tip element is spatula shaped.

12. The dental flossing device of claim 1 where the distal ends of the side supporting elements are rounded.

13. A method for flossing spaces between the teeth of a user having braces, the braces including a brace wire spaced apart from the teeth, the method comprising:
a) a flossing device comprising:
a handle attached to side supporting elements where the handle and side supporting elements are composed in a vertical attachment, the side supporting elements attached to the handle at the proximal ends and descending below the handle;
a central tip element attached at the proximal end to the handle and disposed at a point equidistant between the side supporting elements and where the central tip element is of sufficient width and thickness to enter the space between the tooth and the brace wire;
a floss strand rigidly connected to the distal end of the side supporting elements and passing through the distal end of the central tip element;
b) positioning the central tip element into the space between a tooth and the brace wire such that one of the side supporting elements is positioned in the mouth; and
c) moving the handle in an up and down motion in order to floss between the teeth.

14. The method of claim 13 further comprising the ability to rotate the flossing device such that a second of the side supporting elements is positioned in the mouth to continue flossing when needed.
